(19) United States
(12) Patent Application Publication
(10) Pub. No.: US 2017/0362945 A1
(43) Pub. Date: Dec. 21, 2017

(54) Blade for a Wind Turbine

(71) Applicant: ALSTOM Renewable Technologies, Grenoble (FR)

(72) Inventor: Luca Feigl, Barcelona (ES)

(21) Appl. No.: 15/608,491

(22) Filed: May 30, 2017

Related U.S. Application Data
(63) Continuation of application No. 13/912,051, filed on Jun. 6, 2013.
(60) Provisional application No. 61/682,607, filed on Aug. 13, 2012.

(30) Foreign Application Priority Data
Jun. 11, 2012 (EP) 12382235.5

(51) Int. Cl. F01D 5/30; F03D 1/06

(52) U.S. Cl. CPC F01D 5/30; F03D 1/0658; F05B 2260/30; Y10T 29/49336; Y02P 70/523; Y02E 10/721; F05B 2250/232

(57) ABSTRACT

A blade for a wind turbine comprising a blade root portion is described. The blade root portion defines a mounting surface for coupling to a hub or extender of the wind turbine and comprises a plurality of first holes provided with an insert, the blade root portion further comprises a mounting flange arranged in the periphery of the mounting surface and provided with second holes, wherein the inserts comprise a first end embedded in the blade root portion and a second end opposite to the first end, the second end protruding beyond the mounting surface of the blade root portion, and wherein the second ends are fitted in the second holes of the mounting flange and the mounting flange is attached to the blade by means of the inserts. Furthermore, a wind turbine rotor comprising such a blade is described. Methods of manufacturing half a wind turbine blade and a whole wind turbine blade are also described.

The present application is a Continuation Application of U.S. application Ser. No. 13/912,051, filed Jun. 6, 2013, which claims the benefit of European Patent Application EP 12382235.5 filed on Jun. 11, 2012, and U.S. Provisional Patent Application Ser. No. 61/682,607 filed on Aug. 13, 2012, the disclosures of which are hereby incorporated by reference in their entirety for all purposes.

The present application relates to a blade for a wind turbine and a wind turbine itself. It further relates to methods of manufacturing a wind turbine blade half and a wind turbine blade.

### BACKGROUND ART

The blades in a wind turbine are typically attached, at a blade root portion, to a rotor hub, either directly or through an extender.

Typically, the blades are made from composite materials: reinforcing fibres may be bonded to one another with a resin and, subsequently, cured to consolidate. Different kinds of fibres (e.g. glass, carbon, combinations) and resins (e.g. epoxy) may be used in different forms (e.g. prepreg, fibre sheets). Such composite materials may not have the structural integrity to provide a secure fixing mechanism into which, for example, threaded bolts may be directly inserted. It is thus known for wind turbine blades to comprise metal inserts or bushings which are embedded in the blade root in a direction parallel to that of the longitudinal axis of the blade. Studs, bolts or rods can be used in combination with these bushings to achieve a secure connection between the hub or extender and the blade. It is thus important for a blade root portion to comprise a (circular) mounting surface matching the hub's or extenders' mounting surface.

In general terms a typical manufacturing process of a wind turbine blade may comprise a first step of moulding and curing two separate longitudinal blade shells made out of composite material and a second step of joining together these two blade shells and removing the final blade from the mould. Alternatively, a complete blade may be manufactured in a single moulding step.

Although blades are made from composite material in order to reduce weight, it is important to consider the fact that a finished blade, made of composite, still has a considerable weight. Once a blade has been manufactured it may remain in storage until the wind turbine is finally installed. Said storage may last from e.g. one month up to one year.

Therefore, a problem derived from the above mentioned storage time is that during storage, a blade may deform in a blade root portion due to its own weight. This may cause e.g. an ovalization of a circular blade root mounting surface.

Another problem, related to the one mentioned above derives from accelerating the manufacturing process of the blade. It is becoming common practice nowadays to join two blade shells together and remove them from the mould relatively quickly. In these cases, the resin may not be fully cured yet and the blades may still be relatively soft. Furthermore, composite materials are well-known for shrinking upon curing. Both things may cause a deformation of the blade root portion of the blade that may lead to incompatibilities between the hub and the blade root or to a cumbersome blade mounting process.

In practice, a deformation of the blade root may lead to a more vulnerable attachment at the hub. The attachment holes of the blade root may not be completely aligned with the attachment holes of the hub or extender, and the studs or bolts used for connecting the blade to the hub may not be completely centered in their holes. In operation, these studs or bolts may be subjected to transverse loads, potentially shortening their lifetime and the lifetime of the blades.

For this reason, it is also known to provide e.g. a metal flange along the periphery of the annular mounting surface of the blade root portion. Such a flange helps to provide a more even mounting surface for attachment of the blade to the hub. The mounting flange may be attached to the blade using a plurality of small bolts or screw or adhesives. This however can be rather time consuming, especially when bolts or screws are being used, and furthermore, the small bolts or screws may add local stresses on the blade root portion of the blade thus potentially shortening the lifetime of the blade. It may still happen that deformations occurring during storage, or local deformations caused by the small bolts or screw, cause the holes in the blade on the one hand and the holes in the hub on the other hand to be slightly misaligned.

Thus, there still exists a need to provide a blade with a robust blade root portion such that deformations of its mounting surface are minimized and a robust attachment to a hub or extender of the wind turbine can be provided. At the same time it is desirable that such a blade can be removed from the mould before the curing process is fully completed in order to speed up manufacturing process and be more cost-effective without losing robustness of its blade root portion.

### SUMMARY

According to a first aspect a blade for a wind turbine is provided. The blade comprises a blade root portion defining a mounting surface for coupling to a hub or extender of the wind turbine and comprising a plurality of first holes provided with an insert. The blade root portion further comprises a mounting flange arranged in the periphery of the mounting surface and provided with second holes, wherein the inserts comprise a first end embedded in the blade root portion and a second end opposite to said first end, the second end protruding beyond the mounting surface, and wherein the second ends are fitted in the second holes of the mounting flange and the mounting flange is attached to the blade by means of the inserts.

According to this aspect, the inserts are inserted in the second holes of the mounting flange and at the same they are also embedded in the blade root portion of the blade. This way, the inserts together with the mounting flange may constitute a relatively rigid unity working together against deformation forces acting on the blade root portion thus reducing undesired deformations due to e.g. the blade's own weight and/or due to speeding up the manufacturing process of the blades. Also, the use of such a relatively rigid structure formed by the inserts and the mounting flange contributes towards speeding up the moulding step of the blade as the desired shape and dimensions of the blade root mounting surface may be better ensured. This contributes to a better attachment of the blade to the hub (or to an extender) as a mounting surface fulfilling manufacturing tolerances ensures a proper alignment of the holes of the mounting flange with those of the inserts embedded in the blade root portion of the blade thus enabling proper insertion of fasteners for securing the blade to the hub.

In some embodiments, the mounting flange may be attached to the blade only by means of the inserts. This way no other fastening means such as screws or bolts are required to keep the holes of the flange aligned with the holes of the blade root thus avoiding local stresses on the blade root portion of the blade caused by these screws or bolts. Furthermore, if a further step of joining a mounting flange to a blade may be avoided, the manufacturing process may be faster as the blade can be taken out of the mould before the curing process is complete.

Different ways of fitting the inserts in the holes of the mounting flange may be foreseen.

In some embodiments, one or more second ends of the internal inserts and an inner side of the corresponding second holes may comprise a straight shape and an inner diameter of the second holes may be slightly smaller than an outer diameter of the second ends of the inserts. In these cases, an interference fit between inserts and mounting flange may be achieved by joining these two parts e.g. by shrink fitting.

In some embodiments, one or more second ends of the inserts may comprise an outer surface having a tapered shape. Such a tapered shape in combination with a complementary shape of the second holes of the mounting flange may help to ensure a proper and easy fit between both parts (inserts and mounting flange).

In some embodiments, one or more second ends of the inserts may comprise a protruding element extending in a plane substantially perpendicular to that of a longitudinal axis of the insert and an inner side of the corresponding second holes may comprise an indentation in which said protruding element can be positioned. This way a hooking connection may be established between the mounting flange and the inserts which may not need additional fastening means between both parts.

In some embodiments, one or more second ends of the inserts may comprise a threaded portion and an inner side of the corresponding second holes may comprise an indentation in which a nut, matching said threaded portion, can be inserted. This alternative may be a different way of achieving a hooking connection between the mounting flange and the inserts which may not need additional fastening means between them.

In some embodiments, one or more second ends of the inserts may comprise an external thread and an inner side of the corresponding second holes may comprise a thread that is complementary to the external thread of the inserts.

This is a further alternative for achieving a hooking connection between the mounting flange and the inserts which may not need additional fastening means between them.

Another aspect provides a wind turbine rotor comprising a hub and at least one blade substantially as hereinbefore described.

A further aspect provides a method of manufacturing a wind turbine blade half. The method may comprise the steps of joining a plurality of inserts to half a mounting flange, arranging the resulting assembly inserts-half mounting flange together with fibres in a mould, introducing resin in the mould and curing the resin such that the assembly inserts-half mounting flange is joined to the resin a fibres. This way, the assembly inserts-half mounting flange is moulded together with the fibres resulting in rigid attachment flange-blade through the inserts which are also embedded in the blade root portion of the blade.

Additional objects, advantages and features of embodiments of the present blade will become apparent to those skilled in the art upon examination of the description, or may be learned by practice of the invention.

### BRIEF DESCRIPTION OF THE DRAWINGS

Particular embodiments of the present blade will be described in the following by way of non-limiting examples, with reference to the appended drawings, in which:

FIG. 1 shows a section view of the attachment of a blade root portion of the blade to a pitch bearing of the wind turbine according to an embodiment;

FIGS. 2-5b each show a section view of the attachment insert-mounting flange according to different embodiments;

FIG. 6a shows a mounting flange according to an embodiment; and

FIG. 6b shows an assembly of half a mounting flange-inserts according to an embodiment.

### DETAILED DESCRIPTION OF EMBODIMENTS

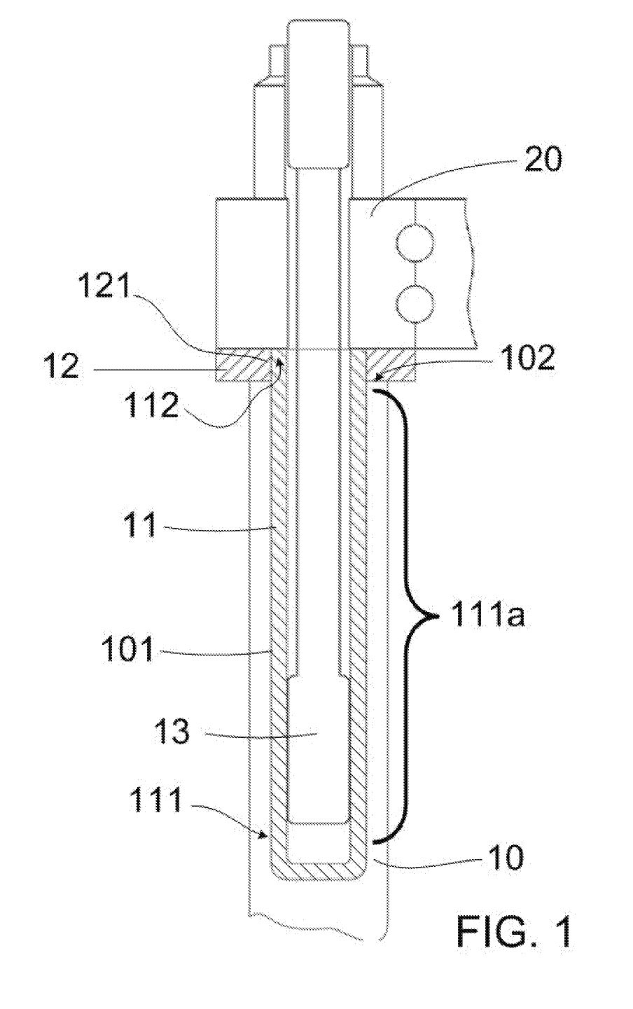

FIG. 1 shows a cross-section of the attachment of a blade to a pitch bearing 20 for attachment to a hub of the wind turbine. The blade may comprise a blade root portion 10 for coupling to a hub of the wind turbine through the pitch bearing 20. In this case, the blade root portion may be substantially annular. The blade root 10 may comprise a plurality of first holes 101 provided with an internal (metal) bushing 11. An annular mounting flange 12 may further be provided along a periphery of an annular mounting surface 102 of the blade root. Said mounting flange 12 may be provided with second holes 121. The bushings 11 may comprise a first end 111 and a main portion 111a embedded in the blade root portion 10 and a second end 112 opposite to said first end 111. Such a second end 112 may protrude beyond the mounting surface 102 and may be fitted in the second holes 121 of the mounting flange 12.

The attachment blade-mounting flange may thus be a relatively rigid connection as the flange is attached to the metal inserts embedded in the blade root portion of the blade. The holes of the mounting flange 121 and the holes 101 of the blade root 10 may thus remain aligned independently on whether the blade is taken out of the mould before the curing process is completed and/or the blade has been left in storage for quite a long time and as mentioned before, this enables a proper insertion of fasteners 13 for securing the blade to the hub.

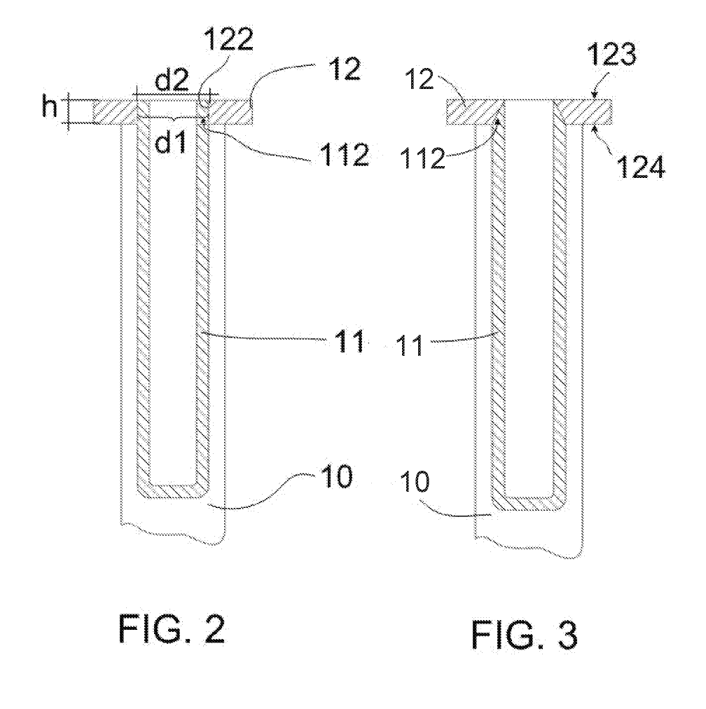

FIG. 2 shows an assembly mounting flange-bushing according to a first embodiment in which an outer surface of the second ends 112 of the bushings 11 and an inner side 122 of the second holes 121 of the mounting flange 12 may comprise a straight shape. In these cases, an inner diameter d2 of the second holes 121 may be smaller than an outer diameter d1 of the second ends 112 of the bushings 11. This way, an interference fit or friction fit may be established between both parts forming the assembly e.g. by using a shrink fitting technique.

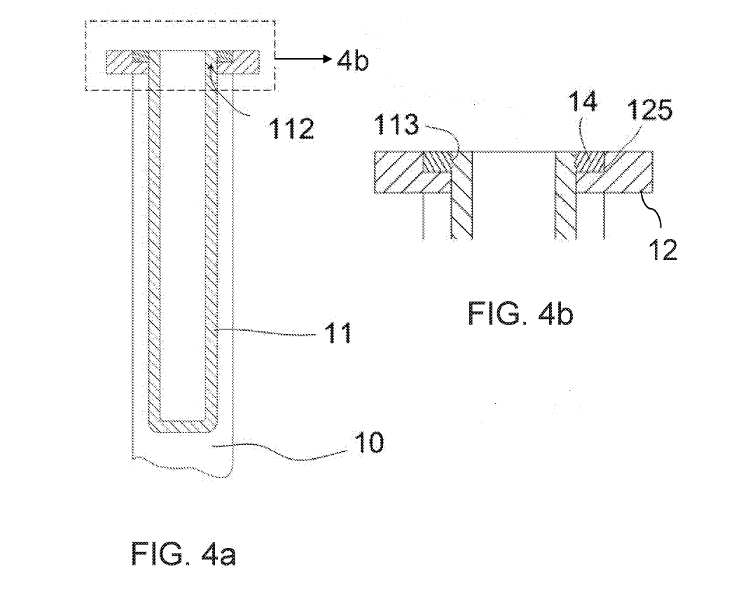

FIG. 3 shows an assembly mounting flange-bushing according to a second embodiment in which an outer surface of the second ends 112 of the bushings 11 may comprise a decreasing outer diameter d2 shape (considering a direction from the first end 111 to second end 112 of the bushing). In these cases, an inner side 122 of the second holes 121 of the mounting flange may comprise a complementary shape having a decreasing inner diameter d2 (considering a direction from a side of the flange 124 facing the blade towards a side of the flange 123 facing the hub when the blade is coupled to the hub).

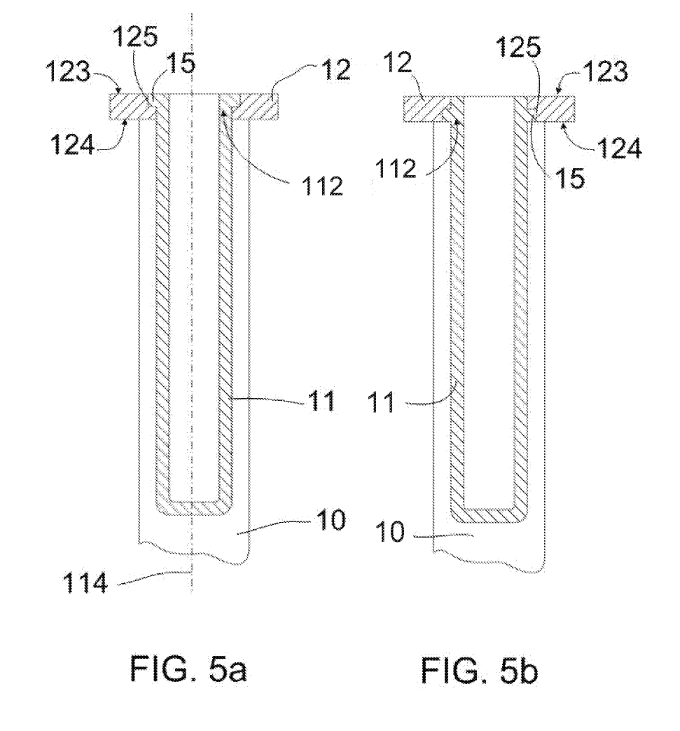

FIG. 4a and its enlarged detail FIG. 4b show an assembly mounting flange-bushing according to a third embodiment in which the second ends 112 of the internal bushings may comprise a threaded portion 113 and an inner side of the corresponding second holes may comprise an indentation 125 in which a nut 14 matching the threaded portion 113 can be inserted. In an alternative embodiment (not shown), the outer surface of the second ends may be threaded and an inner side of the corresponding second holes may comprise a matching thread. With these embodiments, the inserts may be fixed to the mounting flange by screwing either the bushings itself or the nut which result in a rigid attachment between both parts (mounting flange and bushings).

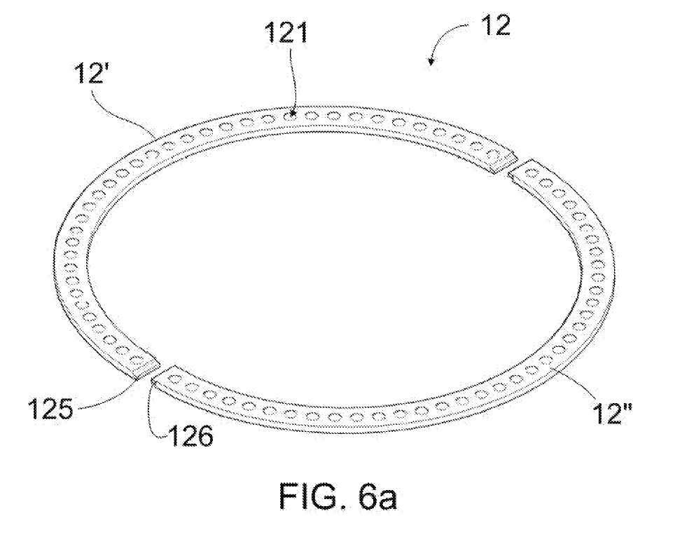

Each of FIGS. 5a and 5b shows an assembly mounting flange-bushing according to a fourth embodiment in which the second ends 112 of the internal bushings may comprise a protruding element 15 arranged extending in a plane substantially perpendicular to that of a longitudinal axis 114 of the bushing and an inner side of the corresponding second holes may comprise an indentation 125 in which said protruding element 15 can be inserted.

FIG. 5a shows an example in which the protrusion 15 may be provided at the end point of the second end 112 of the bushing and the indentation 125 may be arranged close to a side of the flange 123 facing the hub. This embodiment defines a hooking connection between inserts and mounting flange.

FIG. 5b shows an example in which the indentation 125 may be arranged close to a side of the flange 124 facing the blade.

According to the examples shown in FIGS. 1-5b the second ends 112 of the mounting flange may be fully inserted into the second holes 121, this means that the totality of the flange's height in an axial direction (see FIG. 2) of the annular mounting flange and the mounting flange 12 may be attached to the blade root 10 by means of said bushings 11. It should be understood that the second ends of the inserts may also be inserted a different height in an axial direction of the annular mounting flange.

In all previously described cases a further welding point may be added between each insert or bushing and the mounting flange to ensure their attachment. A welded attachment may also be established.

In all cases the inserts may be arranged along the whole blade root portion thus radial rigidity of the blade root portion may be improved.

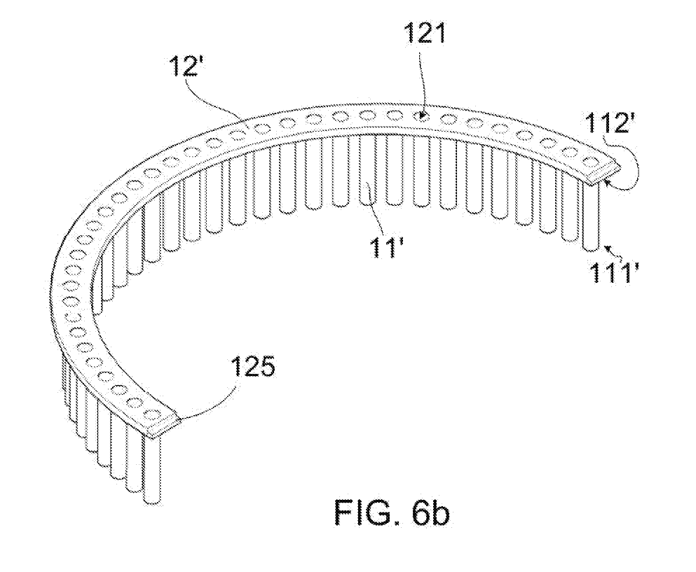

FIG. 6a shows an annular mounting flange 12 according to an embodiment comprising two halves 12′, 12″. Each of the two flange halves 12′, 12″ may comprise through holes 121 equidistantly distributed along its half annular surface. The ends of the flange halves 12′ may be complementary for easy attachment. A flange halve 12′ may comprise e.g. an indentation 125 or similar at each of its ends and the indentations may be complementary to indentations 126 provided at each of the ends of the second half 12″ such that both flange halves 12′, 12″ may be coupled forming an annular mounting flange 12.

In addition to what was shown in FIG. 6a with respect to the annular mounting flange, FIG. 6b shows an assembly of half an annular mounting flange 12′ fitted with metal inserts 11′ according to an embodiment. In FIG. 6b one end 112′ of the metal inserts 11′ may be fitted into the through holes 121 of half an annular mounting flange 12′. The same may be done for the other mounting flange half. The metal inserts 11′ may thus comprise a free end 111′ that may be embedded into fibres forming the blade root portion of the blade.

The present application further describes a method of manufacturing a blade half comprising the steps of joining a plurality of metal inserts 11′ with half an annular mounting flange 12′, then arranging the resulting assembly metal inserts-half a mounting flange together with fibres in a mould, introducing resin in the mould and curing the resin, such that the assembly inserts. The mounting flange half is joined to the resin and fibres. Such an arrangement can be done in the following manner e.g.: positioning prepregs and then curing or arranging fibres first and then introducing the resin e.g. by RTM (Resin Transfer Moulding).

This way a blade shell comprising half a blade root provided with embedded metal inserts which are also attached to half a rigid mounting flange can be manufactured. Such a blade shell may be taken from the mould before the curing process is complete as the assembly metal inserts-mounting flange will maintain the semi-circularity of the blade shell. Furthermore, joining together two blade shells being manufactured as described above result in a blade in which deformations of its blade root mounting surface are at least partly minimized.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

1-18. (canceled)

19. A blade for a wind turbine, comprising:
a blade root portion, the blade root portion defining a mounting surface for coupling to a hub or extender of the wind turbine,
the blade root portion comprising a plurality of first holes, with each first hole provided with an insert,
the blade root portion further comprising a mounting flange arranged in the periphery of the mounting surface and provided with second holes,
wherein the inserts comprise a first end embedded in the blade root portion and a second end opposite to the first end, the second end protruding beyond the mounting surface of the blade root portion,
wherein the second ends are fitted in the second holes of the mounting flange and the mounting flange is attached to the blade by the inserts; and
and wherein the mounting flange comprises two connected mounting flange halves, each mounting flange half having ends with a connecting profile connected to complementary end profiles of the other respective mounting flange half.

20. The blade according to claim 19, wherein the mounting flange is attached to the blade only by the inserts.

21. The blade according to claim 19, wherein one or more second ends of the inserts and an inner side of the corresponding second holes comprise a straight shape and an inner diameter of the second holes is slightly smaller than an outer diameter of the second ends of the inserts.

22. The blade according to claim 19, wherein one or more second ends of the inserts comprises an outer surface having a tapered shape.

23. The blade according to claim 19, wherein one or more second ends of the inserts comprises a protrusion extending in a plane substantially perpendicular to that of a longitudinal axis of the insert and an inner side of the corresponding second holes comprises an indentation in which the protrusion can be positioned.

24. The blade according to claim 19, wherein one or more second ends of the inserts comprises a threaded portion and an inner side of the corresponding second holes comprises an indentation in which a nut, matching the threaded portion, can be inserted.

25. The blade according to claim 19, wherein one or more second ends of the inserts comprises an external thread and an inner side of the corresponding second holes comprises a thread that is complementary to the external thread of the inserts.

26. The blade according to claim 19, wherein the inserts are welded to the second holes.

27. A wind turbine rotor comprising the hub and at least one blade according to claim 19.

28. A wind turbine rotor comprising the hub and at least one blade according to claim 20.

29. A wind turbine rotor comprising the hub and at least one blade according to claim 21.

30. A wind turbine rotor comprising the hub and at least one blade according to claim 22.

31. A wind turbine rotor comprising the hub and at least one blade according to claim 23.

32. A wind turbine rotor comprising the hub and at least one blade according to claim 24.

33. A wind turbine rotor comprising the hub and at least one blade according to claim 25.

34. A wind turbine rotor comprising the hub and at least one blade according to claim 26.
